(19) United States
(12) Patent Application Publication
(10) Pub. No.: US 2007/0192443 A1
(43) Pub. Date: Aug. 16, 2007

(54) Contents download system using wireless internet platform and method thereof

(75) Inventor: Young-Hyun Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/650,314

(22) Filed: Jan. 5, 2007

(30) Foreign Application Priority Data
Jan. 25, 2006 (KR) 2006-0007835

(51) Int. Cl. G06F 15/16

(52) U.S. Cl. 709/219

(57) ABSTRACT

The present invention relates to a contents download system and method a using wireless internet platform. The contents download system of the present invention includes a contents providing server which stores a transmission log including transmission volume information in contents transmission; a short message server which transforms transmission log information into a short message and transmits it when the transmission log information is received from the contents providing server; and a mobile communication terminal which receives contents from the contents providing server. According to the present invention, more efficient contents retransmission as a result of the interruption of the contents transmission occurred in transmitting the contents is possible.

### PRIORITY

This application claims priority under 35 USC §119 to an application entitled “Contents Download System Using Wireless Internet Platform And Method Thereof” filed in the Korean Intellectual Property Office on Jan. 25, 2006 and assigned Serial No. 2006-0007835, the contents of which are incorporated herein by reference.

### BACKGROUND OF THE INVENTION

1. Field of the Invention

The present invention relates generally to contents download method using mobile communication terminals, and in particular to a contents download system and method using a Binary Runtime Environment for Wireless (BREW) scheme with mobile communication terminals capable of downloading contents again from an Application Download Service (ADS) server more efficiently in case of disconnection with the server while downloading contents from the ADS server.

2. Description of the Background Art

In general, the Binary Runtime Environment for Wireless (BREW) scheme is a next generation wireless internet platform designed by Qualcomm for Code Division Multiple Access (CDMA) mobile communication terminals. The wireless internet platform takes the same role of an operating system for personal computers in mobile communication terminals, that is, it is a middleware for running software including, but not limited to games, and moving pictures.

Similarly to a personal computer, the wireless internet platform conveniently provides an environment for downloading programs to a mobile communication terminal or updating, saving, and deleting them, further, using e-mail, short message, real time search, chatting, multi-user game, and so on. As a result, it is possible to download desired data or upgrade software for mobile communication terminals, if necessary, by using mobile communication terminals supporting the BREW technology.

Thus, mobile communication terminals supporting the BREW technology are distinguished on the grounds that users can personally download predetermined software to mobile communication terminals by themselves, unlike the existing platforms based on JAVA. This wireless internet platform contributes to revitalization of the wireless internet, as a standard for mobile communication contents which encounters numerous problems because of different platforms according to each telecommunications service provider.

FIG. 1 is a flow chart that shows an example of contents download method using a general wireless internet platform.

As shown, contents download system using wireless internet platform comprises a BREW Application Download Service (ADS) server 10 and mobile communication terminal 20. Herein, BREW ADS server 10 provides application contents to mobile communication terminal 20 using BREW out of wireless internet platforms. Mobile communication terminal 20 connects with BREW ADS server 10 and downloads relevant contents according to an input command.

The contents download process of the contents download system using BREW with characteristics of the above is as follows:

First, in step S11, mobile communication terminal 20 transmits a connection request signal to BREW ADS server 10. In step S12, in response to the connection request of mobile communication terminal 20, BREW ADS server 10 allows connection and transmits list information of the contents that can be provided to mobile communication terminal 20.

Mobile communication terminal 20 displays contents list information received from BREW ADS server 10 in step S13 and identifies whether relevant list selection command for request of contents transmission among the displayed list is inputted in step S14. Providing that the relevant list is selected, mobile communication terminal 20 requests BREW ADS server 10 to transmit the contents corresponding to the selected list in step S15.

BREW ADS server 10 transmits the requested contents corresponding to contents list to mobile communication terminal 20 in step S16. Accordingly, mobile communication terminal 20 downloads and saves the contents provided by BREW ADS server 10 in step S17. At this time, mobile communication terminal 20 identifies whether the download of the contents in process of downloading and saving is completed in step S18. Providing that the download of the contents is not completed, mobile communication terminal 20 identifies whether the connection with BREW ADS server 10 is broken in step S19.

Providing that the connection with BREW ADS server 10 is not broken, mobile communication terminal, 20 runs the step from S17 to S19. Providing that the connection with BREW ADS server 10 is broken, mobile communication terminal 20 reconnects with BREW ADS server 10 according to the input command and requests BREW ADS server 10 to retransmit the contents in step S21. Hereby, BREW ADS server 10 retransmits the contents requested retransmission to mobile communication terminal 20 in step S22.

Accordingly, in the existing contents download method using the BREW scheme, when the download of the contents is not completed normally because of an unexpected situation such as power-off or release of communication channels during the download of contents from BREW ADS server 10, mobile communication terminal 20 has to reconnect with BREW ADS server 10 and download the same contents again without regard to whether the contents are previously under downloading.

For example, if the connection is broken in a state that portable terminal 20 has already downloaded 99% of total 2M contents and only 1% of the contents has not been downloaded yet from BREW ADS server 10, portable terminal 20 has to download 2M which is a total volume of the contents all over again. This can become an even bigger problem when the connection is broken during downloading huge amount of contents.

Moreover, in the existing contents download method, when contents should be downloaded again because of disconnection during downloading, there exist such problems that holding time of communication channels becomes longer, more overloads can be occurred in the action of BREW ADS server 10, and users pay a charge for downloading the same contents.

### SUMMARY OF THE INVENTION

Accordingly, an object of the present invention is to solve at least the problems and disadvantages of the background art.

An object of the present invention is to provide a contents download system and method which makes it possible to download the same contents more efficiently in case that download is interrupted by disconnection during contents download using a wireless internet platform.

Another object of the present invention is to provide a contents download system and method which makes it possible to download the same contents again more efficiently with reference to the transmission log of server and the receipt log of receiver in case that download is interrupted by disconnection during contents download using wireless internet platform.

The objects of the present invention can be achieved by a contents download system using a wireless internet platform having a contents providing server which stores a transmission log including transmission volume information in contents transmission, transmits the stored transmission log when the contents transmission is interrupted while the contents transmission is not completed, and successively transmits the remaining volume except the prescribed volume information among the total volume of the contents when successive transmission request signal of the contents including the prescribed volume information is received; a short message server which transforms the transmission log information into a short message and transmits it when the transmission log information is received from the contents providing server; and a mobile communication terminal which receives contents by requesting from the contents providing server and stores the receipt log including received volume information, selects a volume information smaller in volume between transmission volume information and receipt volume information as a small volume information according to the inputted command and transmits it to the contents providing server when the transmission log information is received from the short message server after the receipt of the contents is interrupted while it is not completed, and successively receives the contents of which receipt is interrupted based on the small volume information above, according to the present invention.

A contents download system using a wireless internet platform according to the present invention includes a contents providing server which stores a transmission log including transmission volume information in contents transmission, transmits the stored transmission log when the contents transmission is interrupted while the contents transmission is not completed, and successively transmits the remaining volume successively except the prescribed volume information among the total volume of the contents when successive transmission request signal of the contents including the prescribed volume information is received; a short message server which transforms the transmission log information into a short message and transmits it when the transmission log information is received from the contents providing server; and a mobile communication terminal which receives contents by requesting from the contents providing server and stores the receipt log including received volume information, selects small volume information between transmission volume information and received volume information according to the inputted command and transmits it to the contents providing server when the transmission log information is received from the short message server after the receipt of the contents is interrupted while it is not completed, and successively receives the contents of which receipt is interrupted based on the small volume information above, according to the present invention.

The contents providing server connects with the mobile communication terminal when the connection is requested by the mobile communication terminal and transmits list of contents, which can be provided to the mobile communication terminal. The mobile communication terminal requests transmission of contents, which correspond to the relevant list selected with reference to the contents list sent by the contents providing server, to the contents providing server.

The mobile communication terminal transmits receipt acknowledgment signal (ACK) to the short message server when it receives transmission log information from the short message server. The short message server transmits the ACK to the contents providing server.

The contents providing server deletes the stored transmission log information when it receives the ACK. The contents providing server can delete the stored transmission log information when the transmission of contents is completed.

The mobile communication terminal deletes the stored receipt log information when the receipt of contents is completed.

The transmission log information further includes a phone number of the mobile communication terminal, the name of the contents, and identification information of the contents.

The receipt log information further includes information of the contents providing server, the name of the contents, and identification information of the contents.

The successive transmission request signal further includes a phone number of the mobile communication terminal, the name of the contents, and identification information of the contents.

The contents providing server includes a contents management unit which stores and manages contents that can be provided; a user management unit which manages information of users connected through mobile communication terminals; a transmission log management unit which stores and manages transmission log of contents transmitted to the mobile communication terminal; a connection close identification unit which identifies whether connection with the mobile communication terminal is closed or not during the transmission of the contents; and a connection management unit which transmits the contents to the mobile communication terminal through the contents management unit according to the contents transmission request, transmits the transmission log information to the short message server when the connection is closed, and successively transmits the contents of which receipt is interrupted to the mobile communication terminal based on the small volume information when successive transmission request signal is received from the mobile communication terminal.

The mobile communication terminal includes a wireless communication unit which runs communication with the contents providing server and the short message server, then receives the contents from the contents providing server and the transmission log information from the short message server; a contents receipt log management unit which stores and manages the contents receipt log during the receipt of the contents; a connection close identification unit which identifies whether connection with the contents providing server is closed or not during the receipt of the contents; a volume information comparison unit which compares the magnitude of the transmission volume information included in the transmission log information and the received volume information included in the receipt log information when the transmission log information is received from the short message server after the connection with the contents providing server is closed, then selects a small volume information; a display unit which displays the comparison result in the volume information comparison unit and information for selecting whether the successive transmission may be requested or not based on the comparison result above; and a control unit which transmits successive transmission request signal of the contents to the contents providing server through the wireless communication unit when successive transmission request command is inputted corresponding to the displayed information above.

In addition, the object above can be achieved by a contents download method of the mobile communication terminal using a wireless internet platform, including receiving the requested contents from the contents providing server and storing the receipt log including the received volume information; identifying whether the transmission of the contents is interrupted while the receipt of the contents is not completed; receiving the transmission log information including the transmission volume information of the contents transmitted by the contents providing server when it is judged that the transmission of the contents is interrupted; displaying information for selecting whether successive transmission of the contents may be requested or not by selecting small volume information between the transmission volume information and received volume information; sending the successive transmission request signal of the contents including the small volume information to the contents providing server when successive transmission request command is inputted corresponding to the displayed information above; and successively receiving the contents of which receipt is interrupted from the contents providing server based on the successive transmission request signal, according to the present invention.

The contents download method in accordance with the present invention, further including sending receipt acknowledgement signal (ACK) to the contents providing server through the short message server upon receipt of the transmission log information.

The contents download method in accordance with the present invention, further including deleting the stored receipt log information when the receipt of the contents is completed.

Moreover, the object above can be achieved by a mobile communication terminal which can download contents using wireless internet platform including a wireless communication unit which runs communication with the contents providing server and the short message server, then receives the contents from the contents providing server and the transmission log information including the transmission volume information of the contents from the short message server; a contents receipt log management unit which stores and manages the contents receipt log during the receipt of the contents; a connection close identification unit which identifies whether connection with the contents providing server is closed or not during the receipt of the contents; a volume information comparison unit which compares the magnitude of the transmission volume information included in the transmission log information and the receipt volume information included in the receipt log information when the transmission log information is received from the short message server after the connection with the contents providing server is closed, then selects a small volume information; a display unit which displays the comparison result in the volume information comparison unit and information for selecting whether the successive transmission may be requested or not based on the comparison result above; and a control unit which transmits successive transmission request signal of the contents including the small volume information to the contents providing server, and successively receives the contents of which receipt is interrupted from the contents providing server based on the successive transmission request signal, through the wireless communication unit, when successive transmission request command is inputted corresponding to the displayed information above, according to the present invention.

In accordance with the present invention, more efficient contents retransmission as a result of the interruption of the contents transmission occurred in transmitting the contents is possible, by storing the contents transmission log and contents receipt log respectively in process of the contents transmission and download between the contents providing server (BREW ADS server in the present invention) and the mobile communication terminal; transmitting the contents transmission log information to the mobile communication terminal by the contents providing server through the short message server when the connection is broken while transmission of the contents is not completed; comparing the magnitude of the transmission volume included in the contents transmission log information and the received volume included in the contents receipt log stored, selecting the small volume, and transmitting it to the contents providing server at the time of requesting successive transmission of the contents, by the mobile communication terminal; and successively transmitting the remaining volume with respect to the contents of which transmission is interrupted, except for the small volume selected above, to the mobile communication terminal by the contents providing server.

### BRIEF DESCRIPTION OF THE DRAWINGS

The invention will be described in detail with reference to the following drawings in which like numerals refer to like elements. The accompany drawings, which are included to provide a further understanding of the invention and are incorporated by reference herein and constitute a part of this specification, illustrate embodiments of the present invention and together with the description serve to explain the principles of the present invention. In the drawings:

FIG. 1 is a flow chart which illustrates an example of a contents download method using a general wireless internet platform;

FIG. 2 is a block diagram that illustrates a contents download system using a wireless internet platform according to the present invention;

FIG. 3 is a block diagram that illustrates a composition of a BREW ADS server in detail according to the present invention;

FIG. 4 is a block diagram which illustrates a composition of a mobile communication terminal in detail according to the present invention; and

FIG. 5 is a flow diagram that illustrates a contents download method in a mobile communication terminal using a wireless internet platform according to the present invention.

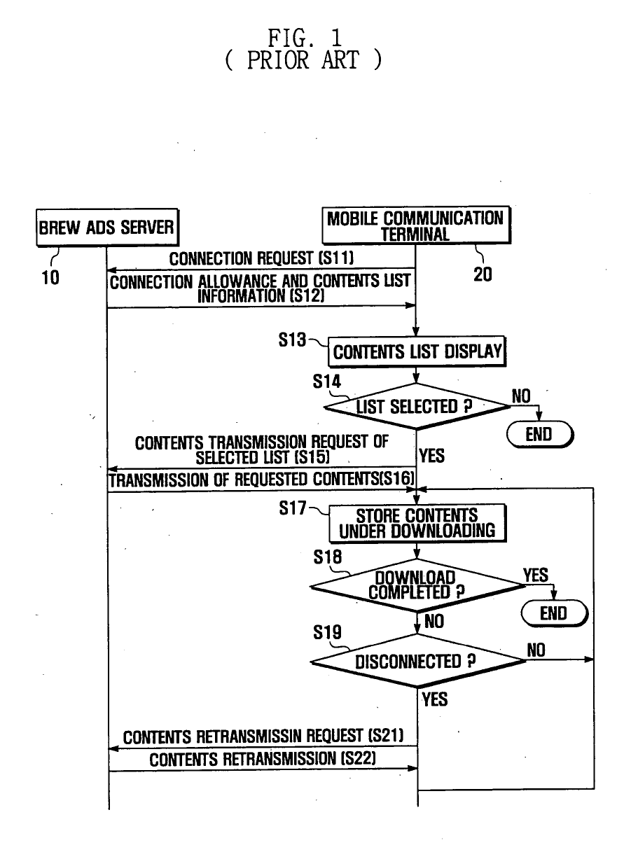

### DETAILED DESCRIPTION OF PREFERRED EMBODIMENTS

Preferred embodiments of the present invention will be described in a more detailed manner with reference to the drawings. Reference will now be made in detail to embodiments of the present invention, examples of which are illustrated in the accompanying drawings.

Hereinafter, preferred embodiments of the present invention will be described in detail with reference to the attached drawings.

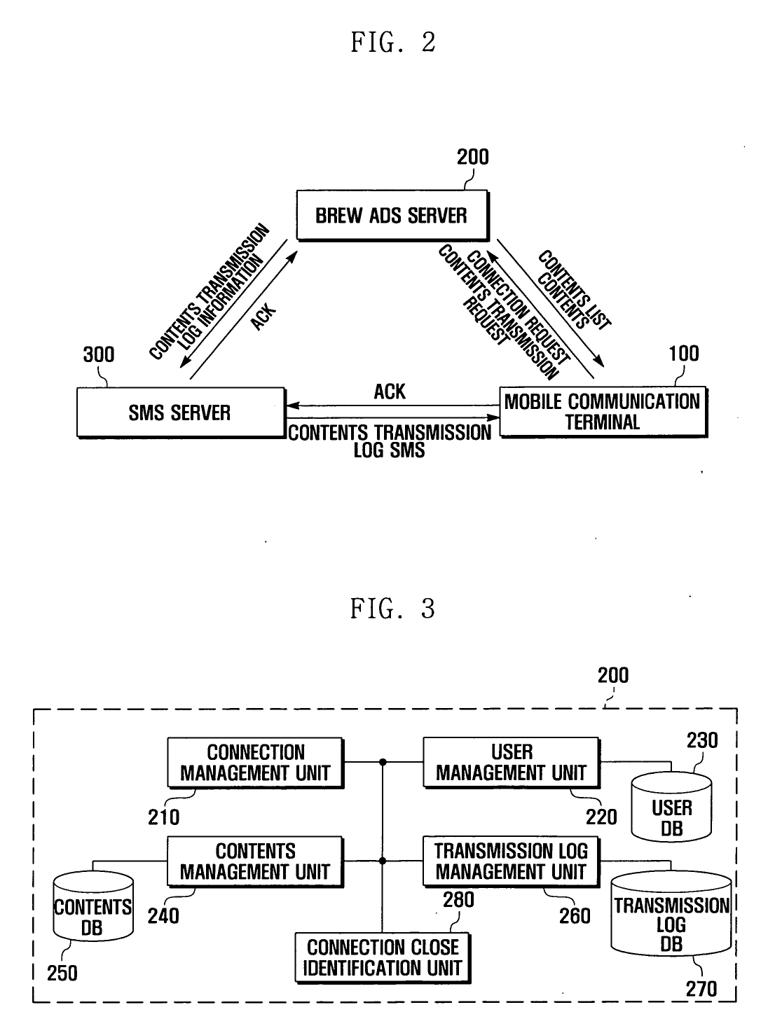

FIG. 2 is a block diagram that illustrates contents download system using wireless internet platform according to the present invention. According to the present invention, the wireless internet platform is BREW, and contents are Application Download Service (ADS) contents which can be executed through BREW.

As shown in FIG. 2, contents download system includes mobile communication terminal 100, BREW ADS server 200, and Short Message Service (SMS) server 300.

Mobile communication terminal 100 transmits connection request signal to BREW ADS server 200 in order to receive the contents, and transmits request signal for corresponding contents to BREW ADS server 200. Mobile communication terminal 100 transmits phone number allocated to mobile communication terminal 100 and user information to BREW ADS server 200 when it sends connection request signal to BREW ADS server 200. Moreover, mobile communication terminal 100 transmits ACK to SMS server 300 when it receives SMS from SMS server 300.

BREW ADS server 200 allows the connection and transmits list of contents which can be provided to mobile communication terminal 100, when mobile communication terminal 100 requests a connection. Also, BREW ADS server 200 provides the contents requested by mobile communication terminal 100 to mobile communication terminal 100. At this time, BREW ADS server 200 stores transmission log including transmission volume information of the contents provided to mobile communication terminal 100. BREW ADS server 200 transmits transmission log information corresponding to the contents provided to mobile communication terminal 100 to SMS server 300, when the transmission of the contents is interrupted because of disconnection with mobile communication terminal 100.

SMS server 300 transforms the transmission log information received from BREW ADS server 200 into a text message and transmits it to mobile communication terminal 100. Further, SMS server 300 transmits ACK to BREW ADS server 200, when ACK is received from mobile communication terminal 100 receiving contents transmission log short message.

After that, mobile communication terminal 100 compares contents transmission volume included in contents transmission log short message transmitted by BREW ADS server 200 through SMS server 300 and contents receipt volume received before disconnection with BREW ADS server 200. At this time, mobile communication terminal 100 displays value of a small volume as a result of the comparison, and displays menu for selecting whether downloading contents successively added to the displayed volume. With respect to this, when a successive contents download command is inputted by user, mobile communication terminal 100 transmits information about corresponding contents of which receipt is interrupted and value of selected volume from each volume included in the transmission log and receipt log to BREW ADS server 200 and requests successive contents transmission.

When the signal requesting the successive transmission of the contents is received from mobile communication terminal 100, BREW ADS server 200 identifies the contents requesting successive transmission and successively transmits the content corresponding to the remaining volume based on value of the selected volume to mobile communication terminal 100.

According to this, mobile communication terminal 100 can successively receive corresponding contents of which receipt is interrupted before. In order for this, in case of being powered-on and rebooted, mobile communication terminal 100 does not delete the incomplete contents of which download is not completed unilaterally, but can delete it according to user's selection. Accordingly, with reference to the contents receipt log and the contents transmission log received from BREW ADS server 200, mobile communication terminal 100 can successively download the contents of which download is not completed at any time.

FIG. 3 is a block diagram that illustrates a composition of a BREW ADS server 200 of FIG. 2 in detail.

As shown, BREW ADS server 200 includes connection management unit 210, user management unit 220, user database (DB) 230, contents management unit 240, contents database 250, transmission log management unit 260, transmission log database 270, and connection close identification unit 280.

Connection management unit 210 controls the connection corresponding to connection request of mobile communication terminal 100, and controls transmission and receipt of the prescribed data with connected mobile communication terminal 100.

User management unit 220 manages information about subscribers to BREW ADS server 200 for the purpose of downloading contents through user (DB) 230. Also, user management unit 220 manages mobile communication terminals connected in order to download contents and mobile communication terminals that are connected with BREW ADS server 200 and request transmission of contents or download the requested contents, through user (DB) 230.

Contents management unit 240 stores and manages contents that can be provided by BREW ADS server 200 through contents database 250.

Transmission log management unit 260, in providing the corresponding contents to mobile communication terminal 100, stores and manages contents transmission log including volume information of corresponding contents transmitted to mobile communication terminal 100 through contents log database 270. Herein, the contents transmission log includes a phone number of mobile communication terminal 100, the name of the contents provided, and identification information of the contents.

Connection close identification unit 280 identifies whether the connection of mobile communication terminal 100 connected with BREW ADS server 200 is closed. In accordance with the present invention, connection close identification unit 280, during the transmission of the corresponding contents requested to the connected mobile communication terminal 100, identifies whether the connection with mobile communication terminal 100 is broken.

According to the identification result of connection close identification unit 280, if the connection between BREW ADS server 200 under transmitting contents and mobile communication terminal 100 is closed, connection management unit 210 transmits contents transmission log information stored in transmission log database 270 to SMS server 300 through transmission log management unit 260.

When successive transmission request signal corresponding to the contents of which transmission is interrupted because of the disconnection during the transmission of the contents is received from mobile communication terminal 100, connection management unit 210, based on the volume information included in successive transmission request signal, successively transmits remaining volume of the contents except for the volume information above to mobile communication terminal 100. For example, if total volume of contents is 2M and volume information included in successive transmission request signal is 1M, connection management unit 210 successively transmits the remaining volume of the total contents of 2M except for 1M to mobile communication terminal 100.

In this way, on the contrary to the existing systems which retransmit total volume of the same contents all over again when the connection is broken during the transmission of the contents, by transmitting, continued on the former transmission of the contents, the remaining volume of the contents except for volume information included in successive transmission request signal requested by mobile communication terminal 100, it is possible to transmit and download the contents more efficiently, because, after transmission and download of the contents is interrupted, by reconnecting, the contents is successively transmitted and downloaded based on the small volume information at the time of interruption of the transmission.

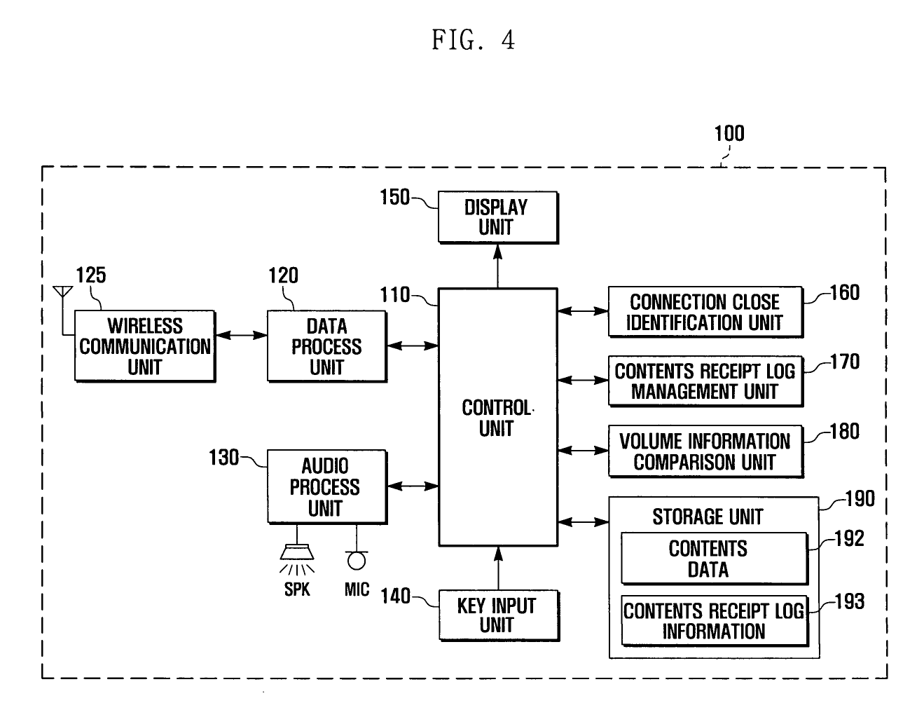

FIG. 4 is a block diagram that illustrates a composition of a mobile communication terminal 100 of FIG. 3 in detail.

As shown, mobile communication terminal 100 includes control unit 110, data process unit 120, wireless communication unit 125, audio process unit 130, key input unit 140, display unit 150, connection close identification unit 160, contents receipt log management unit 170, volume information comparison unit 180, and storage unit 190.

Control unit 110 runs a whole control action of mobile communication terminal 100. Control unit 110, in accordance with the present invention, controls connection with BREW ADS server 200, request of contents providing, contents download, and series of actions for successive download of contents due to disconnection during the download of contents.

Data process unit 120 has a transmission module that encodes and modulates the signal for transmitting through wireless channel and a receipt module which decodes and demodulates the signal received through wireless channel.

Wireless communication unit 125 transmits and receives corresponding data for wireless communication of mobile communication terminal 100. Wireless communication unit 125 can includes an RF transmitter that raises and amplifies the frequency of the transmitted signal, and a RF receiver that amplifies the received signal with low noise and drops the frequency. Wireless communication unit 125 according to the present embodiment connects with BREW ADS server 200 and transmits and receives corresponding data with BREW ADS server 200 through the connected communication channel. Accordingly, wireless communication unit 125 transmits contents transmission request signal to BREW ADS server 200, receives contents transmitted from BREW ADS server 200, and outputs it to data process unit 120.

Audio process unit 130 can include Coder/Decoder (CODEC), and can have data CODEC which process packet data and audio CODEC which process audio signal such as a voice. In case of the voice communication of mobile communication terminal 100, audio process unit 130 transforms the digital audio signal received by data process unit 120 into analog signal through the audio CODEC and replays it through speakers. Further, audio process unit 130 transforms the analog audio signal inputted from microphone into digital audio signal through the audio CODEC and provides it to data process unit 120 through control unit 110. At this time, CODEC can be equipped separately or can be included in control unit 110.

Key input unit 140 has many keys for inputting of number and text information and control keys for controlling actions of mobile communication terminal 100. Key input unit 140 in accordance with the embodiment of the present invention has keys for connecting with BREW ADS server 200 and requesting transmission of contents.

Display unit 150 displays state information according to action of mobile communication terminal 100 under the control of control unit 110. A Liquid Crystal Display (LCD) can be applied to display unit 150, in this case, display unit 150 can have LCD control unit, memory for storing visual data, and LCD display element. In the case embodying the LCD in a touch-screen form, it can play the role of input interface. Display unit 150 according to the present invention displays contents list information transmitted from BREW ADS server 200 and information about running the contents received. Moreover, display unit 150 can display comparison result between contents transmission volume and contents receipt volume, and menu for requesting successive transmission of the contents.

Connection close identification unit 160 identifies whether connection with BREW ADS server 200 is closed. In the present embodiment, connection close identification unit 160 identifies whether connection with BREW ADS server 200 is closed during the download of the contents from BREW ADS server 200 and provides it to control unit 110.

Contents receipt log management unit 170, when the contents are downloaded from BREW ADS server 200, checks the contents receipt log including volume information of downloaded contents and stores it in storage unit 190. Herein, contents receipt log further comprises information of BREW ADS server 200, the name of the contents, and identification information of the contents.

On the other hand, BREW ADS server 200, if the connection with mobile communication terminal 100 is broken during the transmission of the contents to mobile communication terminal 100, transmits contents transmission log information which has been already stored, to SMS server 300. SMS server 300 transforms the contents transmission log information received from BREW ADS server 200 into short message and transmits it to mobile communication terminal 100.

Volume information comparison unit 180, if contents transmission log short message is received from BREW ADS server 200 because of disconnection with BREW ADS server 200 during download of the contents, compares the magnitude of contents transmission volume included in contents transmission log information and contents receipt volume stored by contents receipt log management unit 170. Volume information comparison unit 180, according to the comparison result, selects a small volume between contents transmission volume and contents receipt volume and provides it to control unit 110.

In accordance with this, control unit 110 displays comparison result of volume information comparison unit 180 and selection menu for requesting successive transmission of the contents. In response to this, if a user inputs a contents successive transmission request command, the control unit 110 transmits contents successive transmission request signal to BREW ADS server 200 of FIG. 3. Herein, the contents successive transmission request signal includes a phone number of mobile communication terminal 100, the name of the contents, identification information of the contents, and information of volume comparison result by volume information comparison unit 180.

BREW ADS server 200 receiving contents successive transmission signal transmits, the remaining volume of the contents except for the volume according to volume comparison result out of total volume of the contents requesting successive transmission, to mobile communication terminal 100.

Storage unit 190 stores programs that can be executed through mobile communication terminal 100 and data according to the execution result. In accordance with the present invention, storage unit 190 stores contents data 192 downloaded from BREW ADS server 200 of FIG. 3 and contents receipt log information 193 generated by contents receipt log management unit 170 during the receipt of the contents. When the download of the contents is completed, control unit 110 deletes contents receipt log information 193 stored in storage unit 190.

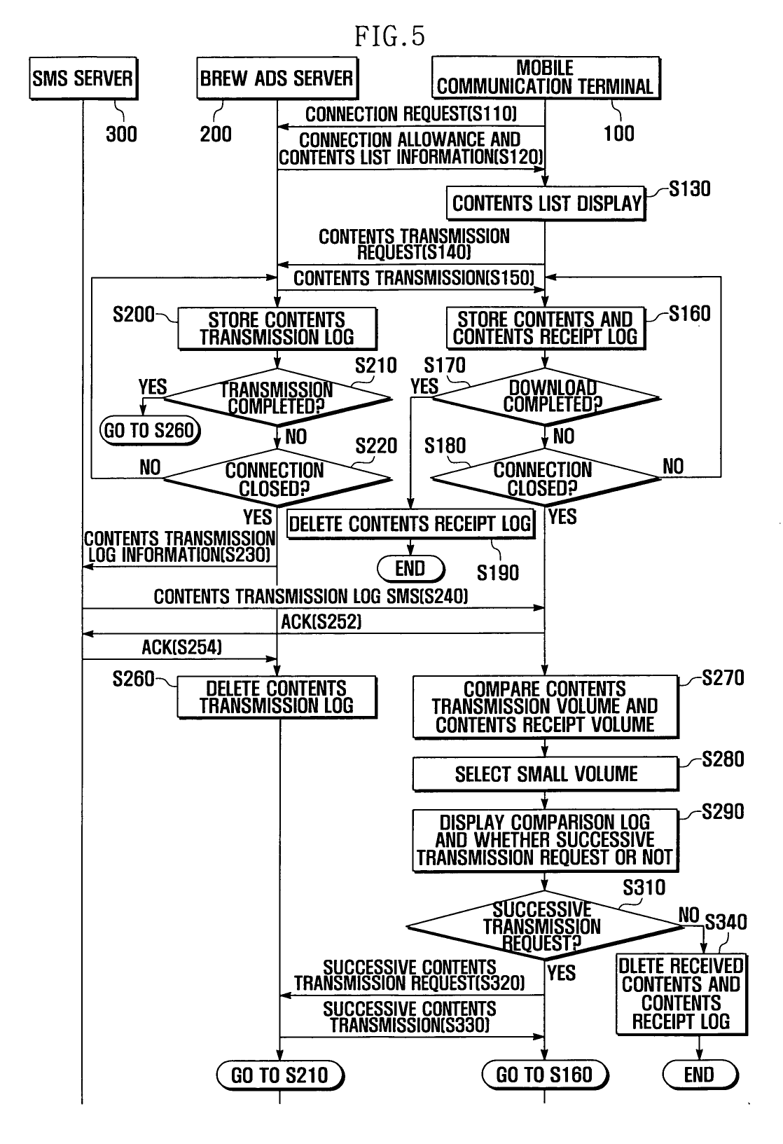

FIG. 5 is a flow diagram which illustrates contents download method in a mobile communication terminal using wireless internet platform according to the present invention.

As shown, first, mobile communication terminal 100, if a connection command with BREW ADS server 200 is inputted in order to download contents, transmits connection request signal to BREW ADS server 200 in step S110. BREW ADS server 200, according to connection request of mobile communication terminal, allows the connection, forms communication channels, and transmits list information of the contents which can be provided to mobile communication terminal 100 in step S120.

Mobile communication terminal 100 displays contents list received from BREW ADS server 200 and waits for selection command about corresponding list for requesting transmission of the contents in step S130. If corresponding list is selected and contents transmission request signal is inputted, mobile communication terminal 100 transmits contents transmission request signal corresponding to the selected list to BREW ADS server 200 in step S140.

Receiving contents transmission request signal, BREW ADS server 200 transmits requested contents to mobile communication terminal 100 in step S150. At this time, BREW ADS server 200 stores transmission log of the contents during the transmission of the contents to mobile communication terminal in step S200. Contents transmission log includes a phone number of mobile communication terminal 100, identification information of the contents, name of the contents, and transmission volume information.

On the other hand, mobile communication terminal 100 downloads and stores the contents transmitted from BREW ADS server 200, and stores receipt log of the contents according to this in step S160. Mobile communication terminal 100 identifies whether the download of the contents is completed in step S170. Providing that download of the contents is completed, mobile communication terminal 100 deletes contents receipt log stored in the step of S160 in step S190.

Providing that download of the contents is not complete, mobile communication terminal 100 identifies whether the connection with BREW ADS server 200 is closed in step S180. Providing that the connection is not closed, mobile communication terminal 100 runs the step from S160 to S180. Providing that the connection is closed, mobile communication terminal 100 waits for receipt of contents transmission log short message transmitted by BREW ADS server 200.

Meanwhile, BREW ADS server 200 identifies whether the transmission of the contents is completed after the step of S200 in step S210. Providing that the transmission of the contents is completed, BREW ADS server 200 deletes contents transmission log stored in the step of S200. Providing that the transmission of the contents completed, BREW ADS server 200 identifies whether the connection with mobile communication terminal 100 is closed during the transmission of the contents in step S220.

Providing that the connection with mobile communication terminal 100 is not closed, BREW ADS server 200 runs the step from S150 to S220. Providing that the connection with mobile communication terminal 100 is closed, BREW ADS server 200 transmits contents transmission log which is stored until the connection is closed to SMS server 300 in step S230.

SMS server 300 transforms contents transmission log information received from BREW ADS server 200 into short message and transmits it to mobile communication terminal 100 in step S240. Receiving contents transmission log information from SMS server 300, mobile communication terminal 100 sends ACK to SMS server 300 in step S252. At this time, receiving ACK from mobile communication terminal 100, SMS server 300 transmits ACK corresponding to this to BREW ADS server 200 in step S254. At this time, receiving ACK from SMS server 300, BREW ADS server 200 deletes contents transmission log stored in the step of S200 in step S260.

On the other hand, mobile communication terminal 100 compares the magnitude of transmission volume included in contents transmission log received in the step of S240 and contents receipt volume stored in the step of S160 in step S270. At this time, mobile communication terminal 100 selects the volume of small value between the transmission volume and the received volume S280. Mobile communication terminal 100 displays comparison log of the volume run in the steps of S270 and S280, and menu for selecting the request of successive transmission of the contents when the download of the contents is interrupted in step S290.

According to this, mobile communication terminal 100 identifies whether the command for successive transmission request of the contents is inputted in step S310. Providing that successive transmission command of the contents is not inputted, mobile communication terminal 100 deletes received contents before the disconnection with BREW ADS server 200 and contents receipt log store in the step of S160 in step S340.

Providing that successive transmission command of the contents is inputted in the step of S310, mobile communication terminal 100 transmits successive transmission request signal of the contents to BREW ADS server 200 in step S320. Herein, successive transmission request signal of the contents includes phone number of mobile communication terminal 100, name of the contents, identification information of the contents, and volume information (volume comparison result information) selected in the step of S280.

Receiving successive transmission request signal of the contents, BREW ADS server 200 identifies a phone number of mobile communication terminal 100, the name of the contents, identification information of the contents, and volume information included in the signal, and successively transmits remaining volume of the contents except the volume of the volume information beyond total volume of the contents in step S330. After this, the phone number of mobile communication terminal 100, the name of the contents, identification information of the contents, and volume information selected in the step of S280 run S210. In addition, receiving the contents successively transmitted from BREW ADS server 200, mobile communication terminal (100) runs S160.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A contents download system using a wireless internet platform comprising:
a contents providing server which stores a transmission log including transmission volume information in contents transmission, transmits the transmission log when the contents transmission is interrupted while the contents transmission is not completed, and successively transmits the remaining volume except a prescribed volume information among a total volume of the contents when a successive transmission request signal of the contents including the prescribed volume information is received;
a short message server which transforms the transmission log information into a short message to transmit when the transmission log information is received from the contents providing server; and
a mobile communication terminal which receives the contents from the contents providing server and stores a receipt log including received volume information of the contents, selects a volume information smaller in volume between transmission volume information and received volume information as a small volume information according to a command and transmits the small volume information to the contents providing server while the small volume information is included in the successive transmission request signal, when the transmission log information is received from the short message server after the receipt of the contents is interrupted while the receipt of the contents is not completed, and successively receives the interrupted contents based on the small volume information.

2. The contents download system of claim 1, wherein
the contents providing server connects with the mobile communication terminal when the connection is requested by the mobile communication terminal and transmits a list of desirable contents to the mobile communication terminal; and
the mobile communication terminal requests transmission of contents, which correspond to a relevant list selected with reference to the list of contents transmitted from the contents providing server, from the contents providing server.

3. The contents download system of claim 1, wherein
the mobile communication terminal transmits a receipt acknowledgment signal (ACK) to the short message server after receiving transmission log information from the short message server; and
the short message server transmits the ACK to the contents providing server.

4. The contents download system of claim 3, wherein the contents providing server deletes the stored transmission log information after receiving the ACK.

5. The contents download system of claim 1, wherein the contents providing server deletes the stored transmission log information after completing the transmission of contents.

6. The contents download system of claim 1, wherein the mobile communication terminal deletes the receipt log information after completing the receipt of contents.

7. The contents download system of claim 1, wherein the transmission log information comprises a phone number of the mobile communication terminal, a name of the contents, and identification information of the contents.

8. The contents download system of claim 1, wherein the receipt log information comprises information of the contents providing server, a name of the contents, and identification information of the contents.

9. The contents download system of claim 1, wherein the successive transmission request signal comprises a phone number of the mobile communication terminal, a name of the contents, and identification information of the contents.

10. The contents download system of claim 1, wherein the contents providing server comprises:
a contents management unit which stores and manages desirable contents;
a user management unit which manages information of users connected through the mobile communication terminal;
a transmission log management unit which stores and manages the transmission log of contents transmitted to the mobile communication terminal;
a connection close identification unit which identifies the close of connection with the mobile communication terminal during the transmission of the contents; and
a connection management unit which transmits the contents to the mobile communication terminal through the contents management unit according to the request of contents transmission, transmits the transmission log information to the short message server when the connection is closed, and successively transmits the interrupted contents to the mobile communication terminal based on the small volume information when the successive transmission request signal is received from the mobile communication terminal.

11. The contents download system of claim 1, wherein the mobile communication terminal comprises:
a wireless communication unit which communicates with the contents providing server and the short message server to receive the contents from the contents providing server and the transmission log information from the short message server;
a contents receipt log management unit which stores and manages the contents receipt log during the receipt of the contents;
a connection close identification unit which identifies the close of connection with the contents providing server during the receipt of the contents;
a volume information comparison unit which compares the magnitude of the transmission volume information included in the transmission log information with the magnitude of the receipt volume information included in the received log information to select a small volume information when the transmission log information is received from the short message server after the connection with the contents providing server is closed;
a display unit which displays the comparison result in the volume information comparison unit and information for selecting the successive transmission request of the contents based on the comparison result; and
a control unit which transmits the successive transmission request signal of the contents to the contents providing server through the wireless communication unit when a successive transmission request command corresponding to the displayed information is inputted.

12. A contents download method of the mobile communication terminal using a wireless internet platform, comprising the steps of:
receiving a requested contents from a contents providing server and storing a received log including received volume information;
identifying whether the transmission of the contents is interrupted while the receipt of the contents is not completed;
receiving the transmission log information including the transmission volume information of the contents transmitted by the contents providing server when it is determined that the contents transmission is interrupted;
displaying information for selecting the request of successive transmission of the contents by selecting a volume information smaller in volume between transmission volume information and received volume information as a small volume information;
transmitting the successive transmission request signal of the contents including the small volume information to the contents providing server when a successive transmission request command corresponding to the displayed information is inputted; and
successively receiving the interrupted contents from the contents providing server based on the successive transmission request signal.

13. The contents download method of claim 12, further comprising sending a receipt acknowledgement signal (ACK) to the contents providing server through the short message server when the transmission log information is received.

14. The contents download method of claim 13, further comprising deleting the stored received log information when the receipt of the contents is completed.

15. The contents download method of claim 12, wherein the transmission log information comprises a phone number of the mobile communication terminal, a name of the contents, and identification information of the contents.

16. The contents download method of claim 12, wherein the received log information comprises information of the contents providing server, a name of the contents, and identification information of the contents.

17. The contents download method of claim 12, wherein the successive transmission request signal comprises a phone number of the mobile communication terminal, a name of the contents, and identification information of the contents.

18. A mobile communication terminal capable of downloading contents using a wireless internet platform comprising:
a wireless communication unit which communicates with a contents providing server and a short message server to receive contents from the contents providing server and to receive transmission log information including transmission volume information of the contents from the short message server;
a contents receipt log management unit which stores and manages a contents receipt log during the receipt of the contents;
a connection close identification unit which identifies the close of connection with the contents providing server during the receipt of the contents;
a volume information comparison unit which compares the magnitude of the transmission volume information included in the transmission log information with the magnitude of the received volume information included in the received log information to select a small volume information when the transmission log information is received from the short message server after the connection with the contents providing server is closed;
a display unit which displays the comparison result in the volume information comparison unit and information for selecting the request of the successive transmission of the contents based on the comparison result; and
a control unit which transmits the successive transmission request signal of the contents including the small volume information to the contents providing server, and successively receives the interrupted contents from the contents providing server based on the successive transmission request signal, through the wireless communication unit, when a successive transmission request command corresponding to the displayed information is input.
